(19) United States
(12) Patent Application Publication
(10) Pub. No.: US 2008/0163479 A1
(43) Pub. Date: Jul. 10, 2008

(54) Needle Roller Bearing Manufacturing Apparatus and Needle Roller Bearing Manufacturing Method

(76) Inventors: Tatsuro Yagi, Aichi (JP); Masaharu Natsume, Aichi (JP); Hiroshi Kawai, Aichi (JP); Toshiharu Sakakibara, Aichi (JP)

Correspondence Address: Muramatsu & Associates, 114 Pacifica, Suite 310, Irvine, CA, 92618, US

(21) Appl. No.: 11/885,614

(22) PCT Filed: Mar. 8, 2006
(86) PCT No.: PCT/JP2006/304478

§ 371 Date: Nov. 19, 2007

(30) Foreign Application Priority Data
Mar. 10, 2005 (JP) 2005-066496

(51) Int. Cl. F16C 43/06; B23P 21/00

(52) U.S. Cl. 29/724; 29/33 K

(57) ABSTRACT

A needle roller bearing manufacturing apparatus and needle roller bearing manufacturing method make it possible to considerably reduce the time required for fitting of rollers and improve the operation efficiency. In the needle roller bearing manufacturing apparatus 1 of the present invention, rollers held in groove portions are fitted in fitting holes of a retainer and a needle roller bearing is assembled, by a rotation of a disc member with a rotation-drive of a motor. In this way, a reciprocating motion of a pusher section which is conventionally carried out in order to fit the rollers is not required. Consequently, there is obtained the effect of being able to considerably reduce the time required for fitting the rollers, thus making it possible to improve the operation efficiency.

### TECHNICAL FIELD

The present invention relates to a needle roller bearing manufacturing apparatus and needle roller bearing manufacturing method and, particularly, to a needle roller bearing manufacturing apparatus and needle roller bearing manufacturing method which can make it possible to considerably reduce time required for fitting of rollers and improve the operation efficiency.

### BACKGROUND ART

A bearing serves to bear a shaft which rotates while being subjected to a load, and includes a plain bearing, which is adapted to bear a shaft through sliding contact between its surface and the shaft while bearing the shaft with the surface, a rolling bearing which is adapted to bear a shaft through rolling contact between a rolling element consisting of balls, rollers or the like, and the shaft, and the like.

Japanese Patent Application Laid-Open Publication No. H 5-50341 discloses a technique for temporarily assembling needles (rollers) in order to manufacture a plain bearing. According to the technique, a needle pusher which is adapted to be reciprocated in one axial direction pushes once needle (roller) into a needle holding groove formed in an outer peripheral surface of a holding shaft so as to be recessed. Next, the holding shaft is rotated and, again, one needle (roller) is pushed into a needle holding groove.

The needles which are arranged in an annular form by repeated reciprocating-motion of the above-mentioned needle pusher and repeated rotations of the holding grooves are pushed at upper end portions thereof downward by falling of an insertion cylinder, and inserted into an interior of a work (an outer ring). In this way, the temporary assembling of the needles (rollers) is carried out in order to manufacture the plain bearing.

Moreover, generally, in a bearing manufacturing apparatus for manufacturing a rolling bearing (needle roller bearing), a pusher section which is adapted to be reciprocated in one axial direction causes one roller to be fitted in fitting holes formed in a retainer. Next, the retainer is rotated and, again, one roller is fitted into the fitting holes. The reciprocating motion of the pusher section and the rotation of the retainer are repeated, to thereby manufacture the rolling bearing.

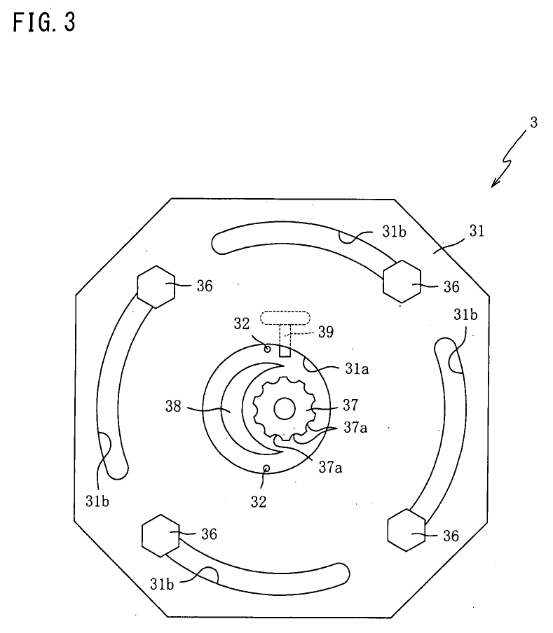

Patent Publication 1: Japanese Patent Application Laid-Open Publication No. H5-50341 (paragraph [0025], FIG. 3, etc.)

### DISCLOSURE OF THE INVENTION

### Problems to be Solved by the Invention

However, in the conventional bearing manufacturing apparatus, it is necessary to cause the retainer to be rotated and cause the rollers to be fitted one by one. Therefore, there is a problem that operation time required for fitting the rollers is increased and the operation efficiency is lowered.

The present invention has been made in order to solve the foregoing problem. It is an object of the present invention to provide a needle roller bearing manufacturing apparatus and method for manufacturing a needle roller bearing, which can considerably reduce time required for fitting rollers, to thereby improve the operation efficiency.

For achieving the object, claim 1 defines a needle roller bearing manufacturing apparatus for manufacturing a needle roller bearing, the needle roller bearing including a cylindrical roller, a retainer having a fitting hole in which the roller is to be fitted, and an outer ring member for holding the roller together with the retainer, the needle roller bearing manufacturing apparatus comprises: a holding section for holding the outer ring member; a disc member arranged on the side of an inner periphery of the outer ring member held in the holding section, and constructed so as to be rotatable; and rotation-drive means for causing the disc member to be rotation-driven; wherein: an axial center of the disc member is disposed eccentrically relative to an axial center of the outer ring member held in the holding section the disc member is formed at an outer peripheral surface thereof with a plurality of groove portions that hold the roller, the groove portions being recessed in a radial direction and spaced uniformly in a peripheral direction; and the rollers held in the groove portions are fitted into the fitting holes of the retainer and the needle roller bearing is assembled, by rotating the disc member with the rotation-drive means.

According to claim 2, in the needle roller bearing manufacturing apparatus according to claim 1, further comprising: a guide member which is formed so as to be curved and spaced at a fixed interval from the outer peripheral surface of the disc member, wherein a feed passage for the roller is provided between opposed surfaces of the guide member and the disc member.

According to claim 3, in the needle roller bearing manufacturing apparatus according to claim 1 or 2, further comprising: positioning means for positioning a relative rotation location of the retainer relative to the disc member.

According to claim 4, in the needle roller bearing manufacturing apparatus according to Claim 2, further comprising: a feed pipe having an inner diameter corresponding to a diameter of the roller, and serving to supply the roller to the feed passage; and a slidable shutter for opening and sealing an interior of the feed pipe.

According to claim 5, in the needle roller bearing manufacturing apparatus according to claim 4, the feed pipe is constructed so as to have a slope relative to a horizontal surface; and a tilt angle defined by the feed pipe and the horizontal surface is set within the range of 5 degrees or more to less than 85 degrees.

According to claim 6, a needle roller bearing manufacturing method for manufacturing a needle roller bearing including a cylindrical roller, a retainer having a fitting hole in which the roller is to be fitted, and an outer ring member for holding the roller together with the retainer, the needle roller bearing manufacturing method comprising: a carrying step for causing the outer ring member and the retainer to be carried on a holding section of a needle roller bearing manufacturing apparatus including the holding section for holding the outer ring member, a disc member arranged on the side of an inner periphery of the outer ring member held in the holding section, and constructed so as to be rotatable, and rotation-drive means for causing the disc member to be rotation-driven, an axial center of the disc member being disposed eccentrically relative to an axial center of the outer ring member held in the holding section, the disc member being formed at an outer peripheral surface thereof with a plurality of groove portions that hold the roller, the groove portions being recessed in a radial direction and spaced uniformly in a peripheral direction; a supply step for supplying the roller to groove portions of the disc member which are located on the side of inner peripheries of the outer ring member and the retainer by the carrying step; a rotation step for causing the roller to be fitted into the fitting hole by rotating the disc member, to which the roller have been supplied by the supplying step, with the rotation-drive means; and a removal step for removing from the holding section the needle bearing in which the roller is fitted by the rotation step.

### Effects of the Invention

According to the needle roller bearing manufacturing apparatus according to claim 1, the disc member which is arranged on the side of the inner peripheral surface of the outer ring member held in the holding section, and constructed so as to be rotatable is arranged with the axial center thereof being eccentric relative to the axial center of the outer ring member held in the holding section, and formed with the plurality of groove portions for holding the rollers, which are recessed in the radial direction and spaced uniformly in the peripheral direction. The disc member is rotated by the rotation-drive means, whereby the rollers held in the groove portions are fitted into the fitting holes of the retainer and the needle roller bearing is assembled. In this way, it is possible to cause the rollers to be fitted into the fitting holes by the rotation of the disc member, so that the reciprocating motion of the pusher section which is conventionally carried out in order to fit the rollers is not required. Consequently, there is obtained the effect of being able to considerably reduce time required for fitting the rollers, thus making it possible to improve the operation efficiency.

Moreover, since the rollers fitted in the fitting holes and the groove portions are engaged with one another, the retainer is slid following the rotation of the disc member. By this, a rotation mechanism for the retainer is not required to be provided separately in order to cause the rollers in turn to be fitted into the fitting holes, and there is obtained the effect of being able to reduce component costs.

According to the needle roller bearing manufacturing apparatus according to claim 2, the feed passage for the rollers is provided between opposed surfaces of the guide member, formed so as to be curved and spaced at the fixed interval from the outer peripheral surface of the disc member, and the disc member, so that there is obtained the effect of being able to cause the rollers to be induced to the fitting holes by the disc member and the guide member, and cause the rollers to be positively fitted into the fitting holes, in addition to the effect taken by the needle roller bearing manufacturing apparatus according to claim 1.

According to the needle roller bearing manufacturing apparatus according to claim 3, the positioning means for positioning the relative rotation location of the retainer relative to the disc member is provided, so that there is obtained the effect of being able to cause the fitting holes to be arranged at positions where the rollers are fitted and cause the rollers to be positively fitted in the fitting holes, in addition to the effect taken by the needle roller bearing manufacturing apparatus according to claim 1 or 2.

According to the needle roller bearing manufacturing apparatus according to claim 4, the interior of the feed pipe, having the inner diameter corresponding to the diameter of each roller and serving to supply the rollers to the feed passage, is opened and sealed by the sliding of the shutter, so that there is obtained the effect of being able to control the number of rollers to be supplied to the feed passage and prevent rollers from being supplied to fitting holes in which rollers are already fitted, in addition to the effect taken by the needle roller bearing manufacturing apparatus according to claim 2.

According to the needle roller bearing manufacturing apparatus according to claim 5, the feed pipe is constructed so as to have the slope relative to the horizontal surface and the tilt angle defined by the feed pipe and the horizontal surface is set within the range of 5 degrees or more to less than 85 degrees, so that there is obtained the effect of being able to cause an abutting area between an upper end surface of a roller supplied to the feed passage, and a lower end surface of a roller stored in the interior of the feed pipe, to be reduced, and cause the rollers to be smoothly supplied to the feed passage, in addition to the effect taken by the needle roller bearing manufacturing apparatus according to claim 4.

According to the needle roller bearing manufacturing method according to claim 6, the rollers are supplied, by the supplying step, to the plurality of groove portions formed in the outer peripheral surface of the disc member so as be recessed in the radial direction. Then, in the rotation step, the disc member which is rotation-driven by the rotation-drive means causes the rollers held in the plurality of groove portions to be fitted into the fitting holes. By this, it is possible to cause the rollers to be fitted into the fitting holes by the rotation-driving of the disc member, without causing the pusher section to be reciprocated in the one axial direction in such a manner as conventionally carried out. Consequently, there is obtained the effect of being able to considerably reduce time required for fitting of the rollers, thus making it possible to improve the operation efficiency.

Moreover, it is possible to cause the retainer to be rotation-driven by the rotation-driving of the disc member, while maintaining an engagement between the rollers fitted into the fitting holes, and the groove portions. By this, it is unnecessary to separately provide a mechanism for rotating the retainer in order to cause rollers newly supplied by the supplying step to be fitted in the fitting holes, so that there is obtained the effect of being able to reduce component costs.

Moreover, the needle roller bearing in which the rollers are fitted by the rotation step is removed from the holding section by the removal step. By this, the needle roller bearing held in the holding section is easily removed, so that there is obtained the effect of being able to improve the operation efficiency.

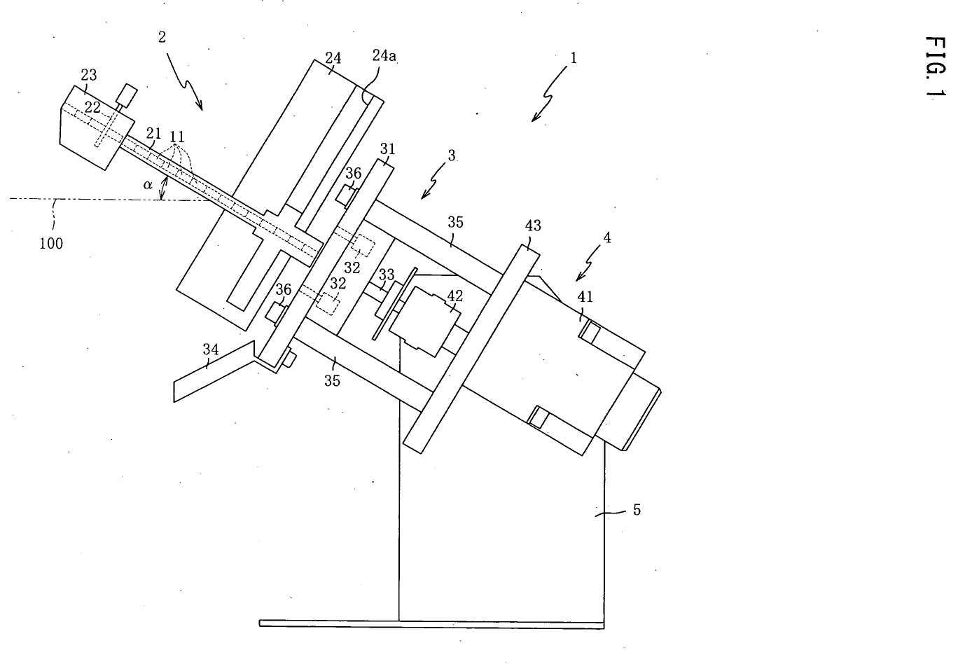

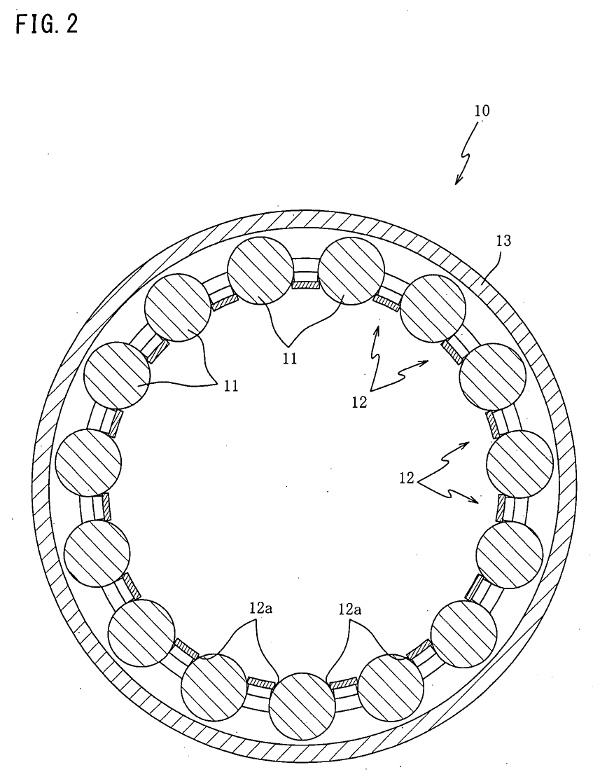

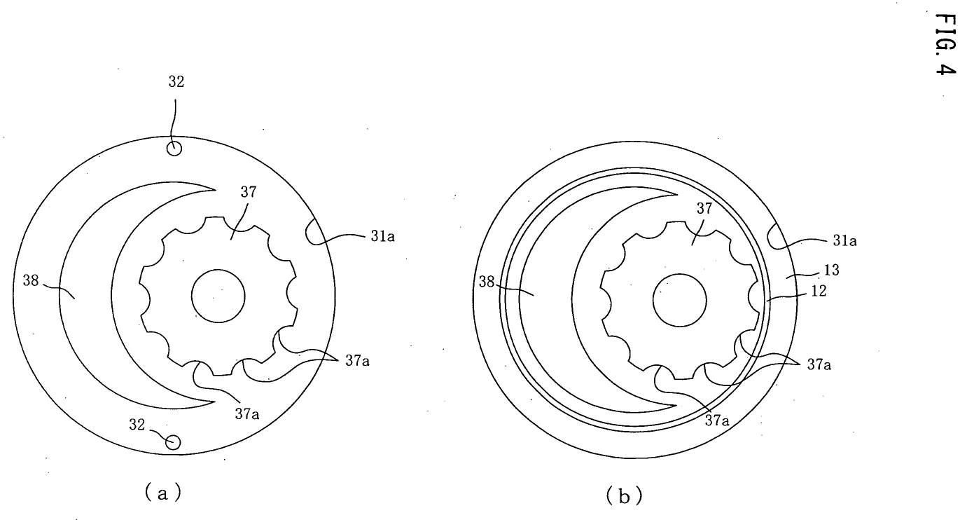

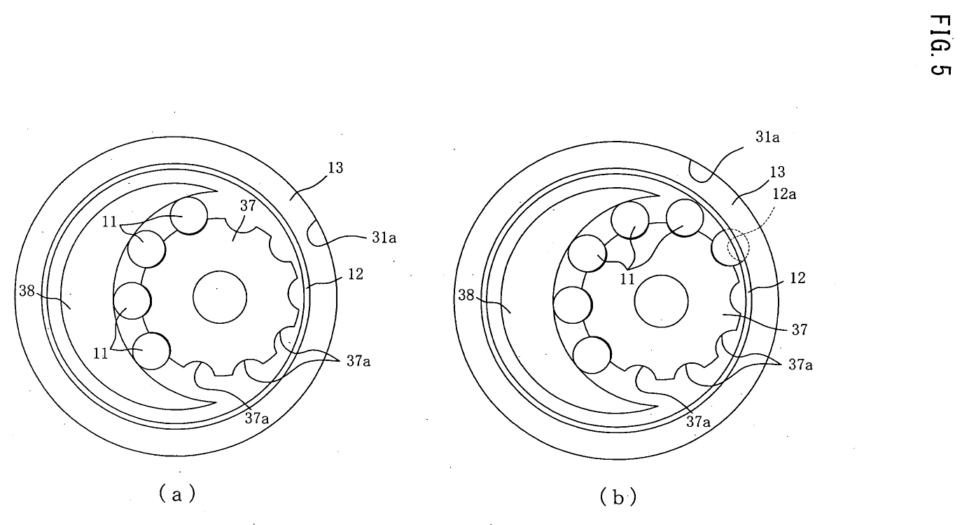

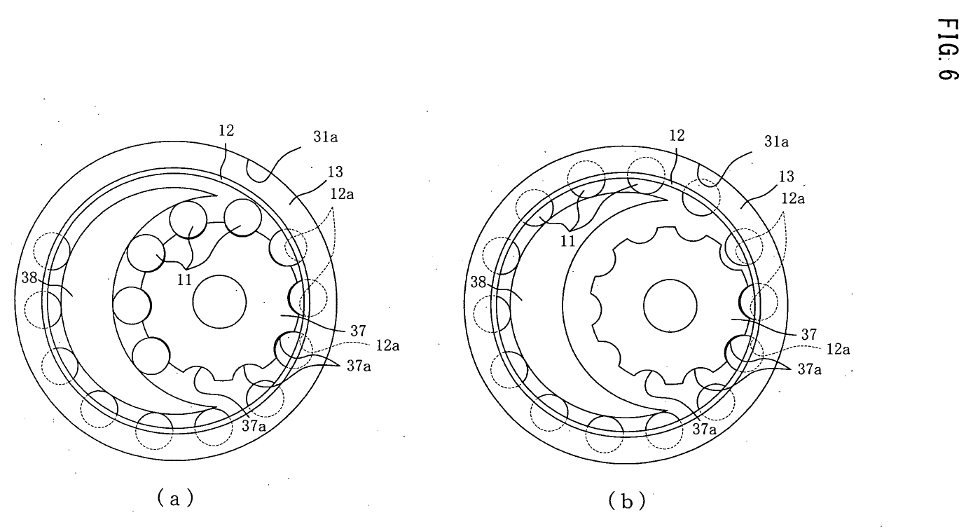

### BRIEF DESCRIPTION OF THE DRAWINGS

[FIG. 1] is a schematic diagram of a needle roller bearing manufacturing apparatus according to an embodiment of the present invention.

[FIG. 2] is a sectional view of a needle roller bearing.

[FIG. 3] is a top plan view of an assembling section.

[FIG. 4] FIG. 4(a) is a top plan view of a holding section, and FIG. 4(b) is a top plan view of the holding section in which an outer ring member is held.

[FIG. 5] FIG. 5(a) is a top plan view of the holding section in which rollers are held in groove portions, and FIG. 5(b) is a top plan view of the holding section at the time that the rollers are fitted into fitting holes.

[FIG. 6] FIG. 6(a) is a top plan view of the holding section at the time of engagement between the rollers fitted in the fitting holes and the groove portions, and FIG. 6(b) is a top plan view of the holding section at the time of the rollers being all fitted in the fitting holes.

### EXPLANATION of Reference Numerals and Symbol

1 Needle roller bearing manufacturing apparatus
10 Needle roller bearing
11 Roller
12 Retainer
12a Fitting hole
13 Outer ring member
21 Feed pipe
22 Shutter
31a Holding section
37 Disc member
37a Groove portion
38 Guide member
39 Detection pin (Positioning means)
41 Motor (Rotation-drive means)
100 Horizontal surface
α Tilt angle

### BEST MODE FOR CARRYING OUT THE INVENTION

A preferred embodiment of the present invention will be explained hereinafter with reference to the accompanying drawings. FIG. 1 is a schematic diagram of a needle roller bearing manufacturing apparatus 1 according to an embodiment of the present invention. Firstly, referring to FIG. 1, an entire structure of the needle roller bearing manufacturing apparatus 1 will be explained.

The needle roller bearing manufacturing apparatus 1 mainly includes a supply section 2 for storing and supplying rollers 11, an assembling section 3 for causing the rollers 11 supplied from the supply section 2 to be fitted in fitting holes 12a (see FIG. 2) described below, and assembling a needle roller bearing 10 (see FIG. 2), and a power section 4 for supplying power to the assembling section 3.

The supply section 2 serves to supply the stored rollers 11 to the assembling section 3, and mainly includes a hollow, tubular feed pipe 21 for storing a predetermined number of the rollers 11, and a shutter 22 provided at an upper end of the feed pipe 21.

The feed pipe 21 is designed such that a size of an inner diameter thereof is substantially equivalent to a size of an outer diameter of the roller 11, and is adapted to store the rollers 11 therein while allowing the rollers to be lined up along a longitudinal direction of the feed pipe, and supply the rollers 11 to the assembling section 3 while causing directions of the rollers 11 to be kept constant. Incidentally, the rollers 11 are adapted to be forced out by pneumatic force of an air supply section 23 arranged at an upper portion of the feed pipe 21. Moreover, above the air supply section 23, a roller storage section (not shown) for storing and supplying a large number of the rollers 11 to the air supply section 23 is provided.

Moreover, at a lower end portion of the feed pipe 21, there is provided a pipe fixing section 24 which is formed with a guide groove 24a in a side surface thereof. The feed pipe 21 is designed so as to be slidable to a retraction position from a supply position to which the rollers 11 are supplied along the guide groove 24a. By this, when the needle roller bearings 10 assembled by the assembling section 3 are to be discharged, the feed pipe 21 is slid from the supply position to the retraction position and the discharging of the needle roller bearings 10 can be prevented from being inhibited by a tip portion of the feed pipe 21.

Moreover, the feed pipe 21 is configured so as to have a slope relative to a horizontal surface 100, and a tilt angle α defined by the feed pipe 21 and the horizontal surface 100 is set within the range of 5 degrees or more to 85 degrees or less. By this, an abutting area between an upper end surface of a roller 11 to be supplied to the assembling section 3 and a lower end surface of a roller 11 in the feed pipe 21 is reduced, thus making it possible to reduce a coefficient of friction between the roller 11 and the assembling section 3 and smoothly supply the rollers. Incidentally, the horizontal surface 100 is given to mean a surface perpendicular to a gravity direction (a vertical direction in FIG. 1).

Moreover, the tilt angle α is preferably set within the range of 30 degrees or more to 60 degrees or less. By this, the coefficient of friction between the roller 11 and the assembling section 3 can be further reduced.

The shutter 22 is provided in the air supply section 23, designed so as to slidable in a direction substantially perpendicular to a direction in which the rollers 11 are supplied and, by the slide of the shutter 22, the feed pipe 21 is opened and sealed. By this, the number of the rollers 11 to be supplied to the assembling section 3 is controlled and supply of the rollers 11 to fitting holes 12a in which the rollers 11 have been fitted can be prevented.

Incidentally, while the shutter 22 in this embodiment is arranged above the feed pipe 21 (upward in FIG. 1), the arranging location of the shutter is not always limited to this and the shutter 22 may be arranged at the lower end of the feed pipe 21, to thereby control the supply of the rollers 11.

The assembling section 3 serves to cause the rollers 11 to be fitted into the fitting holes 12a described below, and then assemble the needle roller bearings 10, and mainly includes a holding plate 31 for holding an outer ring member 13 (see FIG. 2), ejector sections 32 constructed so as to be slidable upward (upward in FIG. 1), a disc member 37 (see FIG. 3) for causing the rollers 11 to be fitted into the fitting holes 12a, a drive shaft 33 continuously connected to the disc member 37, and a discharge section 34 for discharging the needle roller bearings 10.

The holding plate 31 is fastened to support shafts 35 by bolts 36 and provided at a substantially center part thereof with a holding section 31a (see FIG. 3) which is recessed and has an inner diameter substantially equivalent to an outer diameter of the outer ring member 13 in order to hold the outer ring member 13. Incidentally, its details will be discussed hereinafter (see FIG. 3).

A pair of the ejector sections 32 are constructed so as to be slidable upward and are respectively arranged at positions at which upper end surfaces thereof are allowed to be abutted against the outer ring member 13 held in the holding section 31a. By this, when the respective ejector sections 32 are slid upward, the upper end surfaces of the respective ejector sections 32 eject upward the outer ring member 13 held in the holding section 31a. Then, the outer ring member 13 (needle roller bearings 10) ejected upward are discharged through the discharge section 34 while sliding downward (downward in FIG. 1) on an upper end surface of the holding plate 31.

The drive shaft 33 is continuously connected to the disc member 37 described below and is connected to the power section 4. By this, a rotating force of the power section 4 is transmitted to the disc member 37 through the drive shaft 33, and the disc member 33 is rotation-driven.

The power section 4 serves to cause the disc member 37 to be rotation-driven and is fixed to a frame 5 through a motor mounting plate 43. As discussed above, the rotating force of a motor 41 is transmitted to the drive shaft 33 through a connecting portion 42, and the disc member 37 is rotation-driven.

Next, referring to FIG. 2, the details of the needle roller bearing 10 will be explained. FIG. 2 is a sectional view of the needle roller bearing 10.

The needle roller bearing 10 includes the cylindrical rollers 11, a retainer 12 having the fitting holes 12a in which the rollers 11 are fitted, and the outer ring member 13 holding the rollers 11, together with the retainer 12.

The rollers 11 are cylindrical rolling elements, and portions which are to be abutted against a shaft (not shown) to which the needle roller bearing 10 is to be mounted.

The retainer 12 is held by the outer ring member 13, constructed so as to be slidable in a circumferential direction, and formed in the side surface thereof with the fitting holes 12a in which the rollers 11 are to be fitted and which are spaced uniformly (24 degrees) in the circumferential direction.

The fitting hole 12a is designed such that its size measured in a width direction (the circumferential direction in FIG. 2) is smaller than a size of the outer diameter of the roller 11. By this, the rollers 11 fitted in the fitting holes 12a are prevented from dropping out. Incidentally, when the rollers 11 are to be fitted into the fitting holes 12a, the retainer 12 is elastically deformed, whereby the rollers 11 are fitted in the fitting holes 12a.

Next, referring to FIG. 3, the details of the assembling section 3 will be explained. FIG. 3 is a top plan view of the assembling section 3.

The assembling section 3 serves to assemble the needle roller bearing 10 (see FIG. 2) by causing the rollers 11 (see FIG. 2) supplied to the supply section 2 (see FIG. 1) to be fitted into the fitting holes 12a (see FIG. 2) as discussed above, and mainly includes the holding section 31a formed at the substantially center part of the holding plate 31 so as to be recessed, the disc member 37 arranged eccentrically relative to an axial center of the holding section 31a, a guide member 38 of a crescent shape spaced at a fixed interval from an outer circumferential surface of the disc member 37, and a detection pin 39 projecting from a bottom surface of the holding section 31a.

The holding plate 31 is formed at the substantially center thereof with the holding section 31a which is recessed, and clamp-fixed, through support grooves 31b formed around an outer periphery of the holding section 31a, to the support shafts 35 (see FIG. 1) by means of the bolts 36.

The holding section 31a serves to hold the outer ring member 13 (see FIG. 2) and is designed such that the size of the inner diameter thereof is substantially equivalent to the size of the outer diameter of the outer ring member 13 as discussed above. Moreover, a pair of the ejector sections 32 are arranged on the inner peripheral side of the holding section 31a, and constructed so as to be slidable upward (in such a direction as to be short of a surface of the sheet of FIG. 3).

Incidentally, while the two ejector sections 32 are employed in this embodiment, the number of the ejector sections 32 is not always limited to two and may be one or three or more. That is, the number of the ejector sections 32 may be number that is enough to obtain a pushing force which allows the outer ring member 13 to be ejected upward as discussed above.

The disc member 37 is arranged such that its axial center is eccentric relative to the axial center of the holding part 31a, and is designed so as to be rotatable in a clockwise direction in Figure by the rotation-drive of the above-mentioned motor 41. Moreover, the disc member 37 is formed with a plurality of groove portions 37a which are recessed in a radial direction of the disc member 37 and spaced uniformly (at intervals of 36 degrees) around the outer periphery of the disc member 37.

Each groove portion 37a serves to hold the roller 11 supplied from the supply section 2, and is substantially circular arc-shaped and designed such that a radius of the circular arc shape is substantially equivalent to a radius of the roller 11.

Incidentally, while the groove portion 37a in this embodiment is substantially circular arc-shaped, the shape of the groove portion 37a is not always limited to this and may be substantially rectangle-shaped. That is, as far as the groove portion 37a can hold the roller 11, the groove portion 37a may have any suitable shape.

Moreover, a distance between adjacent groove portions 37a is set so as to be substantially equal to a distance between adjacent fitting holes 12a (see FIG. 2). By this, the disc member 37 can cause the rollers 11 (see FIG. 2) held in the groove portions 37a to be in turn fitted into the fitting holes 12a.

Incidentally, while ten groove portions 37a are provided in this embodiment, the number of the groove portions 37a is not always limited to this and can be suitably varied according to a size of the outer diameter of the disc member 37.

The guide member 38 is spaced at the fixed interval from an outer peripheral surface on one side (left side in FIG. 3) of the disc member 37, and formed into a crescent-shape so as to cover the disc member 37. The spaced interval between the guide member 38 and the disc member 37 is set in such a manner that the outer peripheral surface of the roller 11 fitted in the groove portion 37a and the guide member 38 are allowed to be slightly spaced away from each other. By this, when the disc member 37 is rotated, the rollers 11 held in the groove portions 37a can be induced along a feed passage while being prevented from dropping out of the groove portions 37a and falling.

Incidentally, the feed passage recited in claim 2 is given to mean a passage that is provided between opposed surfaces of the disc member 37 and the guide member 38.

The detection pin 39 serves to position a relative rotation-position of the retainer 12 with respect to the outer ring member 13 held in the holding section 31a, and is constructed so as to be slidable vertically (a direction perpendicular to a surface of the sheet of FIG. 3). By this, when initial one of the rollers 11 to be held by the disc member 37 is to be fitted into a fitting hole 12a, the presence or absence of the fitting hole 12a at a fitting position is detected and the fitting hole 12a can be located at the fitting position by causing the retainer 12 to be slid in the circumferential direction.

Next, referring to FIG. 4 to FIG. 6, a manufacturing method for a needle roller bearing 10 will be explained. FIG. 4(a) is a top plan view of the holding section 31a. FIG. 4(b) is a top plan view of the holding section 31a in which the outer ring member 13 is held. FIG. 5(a) is a top plan view of the holding section 31a in which rollers 11 are held in groove portions 37a. FIG. 5(b) is a top plan view of the holding section 31a at the time that a roller 11 is fitted in a fitting hole 12a. FIG. 6(a) is a top plan view of the holding section 31a at the time that rollers 11 fitted in fitting holes 12a and groove portions 37a are engaged with one another. FIG. 6(b) is a top plan view of the holding section 31a at the time that the rollers 11 are all fitted in the fitting holes 12a. Incidentally, in FIGS. 4 to 6, the detection pin 39 has been left out of these illustrations in order to facilitate understanding.

When the needle roller bearing 10 is to be manufactured by the needle roller bearing manufacturing apparatus 1, a carrying step is initially carried out. In the carrying step, the outer ring member 13 and the retainer 12 are carried on the holding section 31a shown in FIG. 4(a). At this time, as shown in FIG. 4(b), the ejector sections 32 are concealed by the outer ring member 13. That is, the upper end surfaces of the ejector sections 32 and the side surface of the outer ring member 13 are abutted against each other. Moreover, the disc member 37 and the guide member 38 are arranged so as to be spaced apart from the retainer 12.

After the carrying step, the process is progressed to a supplying step. In the supplying step, the rollers 11 are supplied to the feed passage shown in FIG. 4(b). At this time, the rollers 11 are held in groove portions 37a located under the feed pipe 21 (see FIG. 1) since the feed pipe 21 is located downward in FIG. 4(b) rather than the axial center of the holding section 31a.

Moreover, when the rollers 11 are fed from the feed pipe 21 as shown in FIG. 5(a), the disc member 37 is rotation-driven in the clockwise direction in the Figure, so that the rollers 11 held in the groove portions 37a are induced along the feed passage and rollers 11 which are newly fed from the feed pipe 21 are held in the groove portions 37a. At this time, the rollers 11 are prevented from dropping out of the groove portions 37a and falling, since the guide member 38 is arranged so as to be slightly spaced apart from the rollers 11 held in the groove portions 37a.

After the supplying step, the process is progressed to a rotation step. In the rotation step, the rollers 11 which have been induced along the feed passage are induced to the fitting holes 12a by the rotation-drive of the disc member 37. Then, as shown in FIG. 5(b), the rollers 11 which have been induced to the fitting holes 12a are fitted into the fitting holes 12a by the rotation-drive of the disc member 37.

Incidentally, the above-mentioned detection pin 39 (see FIG. 3) is slid upward (in such a direction as to be short of a surface of the sheet of FIG. 5(b)), causes the fitting holes 12a of the retainer 12 to be located at locations at which the rollers 11 can be fitted and, thereafter, is slid downward (in the direction of back of the sheet of FIG. 5(b)). By this, the fitting of the rollers 11 into the fitting holes 12a can be correctly carried out.

Then, the disc member 37 is rotation-driven while causing the engagement between the rollers 11 fitted in the fitting holes 12a and the groove portions 37a to be maintained, whereby the retainer 12 is rotation-driven in the clockwise direction in FIG. 6(a) as shown in FIG. 6(a). Simultaneously, the rollers 11 which are newly induced to the fitting holes 12a are fitted into the fitting holes 12a. The disc member 37 is further rotation-driven, whereby the new rollers 11 in turn are fitted into the fitting holes 12a and then fitted into all of the fitting holes 12a as shown in FIG. 6(b) and the production of the needle roller bearing 10 is completed.

Incidentally, as discussed above, the number of the rollers 11 to be fed to the feed passage from the feed pipe 21 is controlled by the operation of the shutter 22 so as to be equal to the number of the fitting holes 12a (in this embodiment, fifteen rollers).

In this way, the rollers 11 can be fitted into the fitting holes 12a by the rotation-drive of the disc member 37, so that the reciprocating motion of the pusher section which is conventionally carried out is not required. Consequently, time required for fitting of the rollers 11 is considerably reduced, thus making it possible to improve the operation efficiency.

Moreover, since the retainer 12 is slid following the rotation-drive of the disc member 37, a mechanism for causing the retainer 12 to be slid is not required to be provided separately, thus making it possible to reduce component costs.

Incidentally, in the conventional needle roller bearing manufacturing apparatus, time required to cause the pusher section to be reciprocated in one axial direction in one cycle and carry out the fitting of one roller by the rotation of the retainer was about 0.4 seconds, and time required to cause fifteen rollers to be all fitted into the fitting holes was about six seconds (0.4 seconds×15). In contrast, in the needle roller bearing manufacturing apparatus 1 according to the embodiment of the present invention, time required to cause the fifteen rollers 11 to be all fitted in the fitting holes 12a by the above-mentioned rotation step is about 2 seconds (namely, time required in 1.5 rotations of the disc member 37), thus making it possible to considerably reduce the work time.

After the rotation step, the process is progressed to a removal step. In the removal step, the ejector sections 32 (see FIG. 4(a)) are slid upward (in such a direction as to be short of the surface of the sheet of FIG. 6), to thereby push the outer ring member 13 as discussed above, and the needle roller bearing 10 is pushed out of the holding section 31a. The needle roller bearing 10 is discharged from the discharge section 34 while being slid on the upper surface of the holding plate 31 (see FIG. 1). Then, the steps (FIG. 4(a) to FIG. 6(b)) including from the carrying step, in which the outer ring member 13 and the retainer 12 are carried on the holding section 31a, to the removal step are again repeated, whereby needle roller bearings 10 in turn are manufactured.

While the present invention is explained above based on the embodiment of the present invention, it is easily recognized that the present invention is not limited to the embodiment but various improvements and changes may be made in the present invention without departing from the summary of the invention.

While the retainer 12 in the embodiment is formed with the fifteen fitting holes 12a, it is not always limited to this and may be formed with fourteen fitting holes or less, or sixteen fitting holes or more.

1. A needle roller bearing manufacturing apparatus for manufacturing a needle roller bearing, the needle roller bearing including a cylindrical roller, a retainer having a fitting hole in which the roller is to be fitted, and an outer ring member for holding the roller together with the retainer, the needle roller bearing manufacturing apparatus comprises:
a holding section for holding the outer ring member;
a disc member arranged on the side of an inner periphery of the outer ring member held in the holding section, and constructed so as to be rotatable; and
rotation-drive means for causing the disc member to be rotation-driven;
wherein: an axial center of the disc member is disposed eccentrically relative to an axial center of the outer ring member held in the holding section;
the disc member is formed at an outer peripheral surface thereof with a plurality of groove portions that hold the roller, the groove portions being recessed in a radial direction and spaced uniformly in a peripheral direction; and
the rollers held in the groove portions are fitted into the fitting holes of the retainer and the needle roller bearing is assembled, by rotating the disc member with the rotation-drive means.

2. The needle roller bearing manufacturing apparatus according to claim 1, further comprising:
a guide member which is formed so as to be curved and spaced at a fixed interval from the outer peripheral surface of the disc member,
wherein a feed passage for the roller is provided between opposed surfaces of the guide member and the disc member.

3. The needle roller bearing manufacturing apparatus according to claim 1, further comprising:
positioning means for positioning a relative rotation location of the retainer relative to the disc member.

4. The needle roller bearing manufacturing apparatus according to claim 2, further comprising:
a feed pipe having an inner diameter corresponding to a diameter of the roller, and serving to supply the roller to the feed passage; and
a slidable shutter for opening and sealing an interior of the feed pipe.

5. The needle roller bearing manufacturing apparatus according to claim 4,
wherein the feed pipe is constructed so as to have a slope relative to a horizontal surface; and
a tilt angle defined by the feed pipe and the horizontal surface is set within the range of 5 degrees or more to less than 85 degrees.

6. A needle roller bearing manufacturing method for manufacturing a needle roller bearing including a cylindrical roller, a retainer having a fitting hole in which the roller is to be fitted, and an outer ring member for holding the roller together with the retainer, the needle roller bearing manufacturing method comprising:
a carrying step for causing the outer ring member and the retainer to be carried on a holding section of a needle roller bearing manufacturing apparatus including the holding section for holding the outer ring member, a disc member arranged on the side of an inner periphery of the outer ring member held in the holding section, and constructed so as to be rotatable, and rotation-drive means for causing the disc member to be rotation-driven, an axial center of the disc member being disposed eccentrically relative to an axial center of the outer ring member held in the holding section, the disc member being formed at an outer peripheral surface thereof with a plurality of groove portions that hold the roller, the groove portions being recessed in a radial direction and spaced uniformly in a peripheral direction;
a supply step for supplying the roller to groove portions of the disc member which are located on the side of inner peripheries of the outer ring member and the retainer by the carrying step;
a rotation step for causing the roller to be fitted into the fitting hole by rotating the disc member, to which the roller have been supplied by the supplying step, with the rotation-drive means; and
a removal step for removing from the holding section the needle bearing in which the roller is fitted by the rotation step.
